(19) United States
(12) Patent Application Publication
(10) Pub. No.: US 2016/0078521 A1
(43) Pub. Date: Mar. 17, 2016

(54) SYSTEMS AND METHODS FOR RECOMMENDING A SERVICE FOR USE BY A PARTICULAR USER

(71) Applicant: KONINKLIJKE PHILIPS N.V., EINDHOVEN (NL)

(72) Inventors: Ronald Leo Christiaan KOYMANS, Eindhoven (NL); Frank WARTENA, Eindhoven (NL); LIsa RUNCI, Andover, MA (US)

(21) Appl. No.: 14/488,437

(22) Filed: Sep. 17, 2014

(51) Int. Cl. G06Q 30/06; G06F 19/00

(52) U.S. Cl. CPC G06Q 30/0631; G06F 19/327

(57) ABSTRACT

A system for recommending a service for use by a particular user comprises a processor and a computer-readable storage medium, wherein the computer-readable storage medium contains instructions for execution by the processor. The instructions cause the processor to perform the steps of selecting from a plurality of users similar users that are similar to the particular user, collecting services used by similar users, determining for collected services the level of satisfaction of similar users using the respective collected service, and recommending a service for use by the particular user from the collected services based on the determined levels of satisfaction of similar users.

### FIELD OF THE INVENTION

The present invention relates to systems and methods for recommending a service for use by a particular user.

### BACKGROUND OF THE INVENTION

When people can get access to a multitude of services, e.g. through a single portal or platform, it can be challenging to recommend services that are both relevant and suitable to them. Services in this context may be any kind of services that can be used by a user and that in any way may support the user or may be desired by the user. In a preferred application services are healthcare services, i.e. any healthcare related services that are related in any way to the health of a user, as conventionally recommended to users by care providers or other health related professionals such as dieticians or physical therapists. Services may be recommended directly to the user, but may also be recommended to a third party, e.g. a care provider, who may then forward said recommendation to the user or may use said recommendation to apply a service to the user who is then using said service.

Recommendation of one or more services for use by a user using a portal or platform has not yet been efficiently addressed. Known solutions do not provide sufficiently reliable recommendations.

### SUMMARY OF THE INVENTION

It is an object of the present invention to provide systems and methods for recommending relevant and suitable services for use by a particular user.

In a first aspect of the present invention a system for recommending a service for use by a particular user is presented, the system comprising a processor and a computer-readable storage medium, wherein the computer-readable storage medium contains instructions for execution by the processor, wherein the instructions cause the processor to perform the steps of:
selecting from a plurality of users similar users that are similar to the particular user,
collecting services used by similar users,
determining for collected services the level of satisfaction of similar users using the respective collected service, and
recommending a service for use by the particular user from the collected services based on the determined levels of satisfaction of similar users.

In a further aspect of the present invention a system for recommending a service to a particular user is presented, the system comprising:
a selector configured to select from a plurality of users similar users that are similar to the particular user,
a collector configured to collect services used by similar users,
a level of satisfaction determination unit configured to determine for collected services the level of satisfaction of similar users using the respective collected service, and
a recommender configured to recommend a service for use by the particular user from the collected services based on the determined levels of satisfaction.

According to these aspects more relevant and suitable services are recommended by looking at the satisfaction of similar users of such services. Hereby, the level of satisfaction can be based on direct feedback from users, for instance by means of a questionnaire, and/or the actual usage of such services by users, for instance by IT tools such as monitoring and logging.

Determining similarity of users of a service is a well-known problem that can be based on profiling of users. On the basis of two profiles a measure of their (relative) similarity can be defined that depends on how (relatively) close the parameters of the two profiles (e.g., age, gender) are. An embodiment for matching user profiles to determine similarity of users is e.g. described in Andra Cali et al. “A Logic-Based Approach for Matching User Profiles”, Springer Verlag, M. Gh. Negoita et al. (Eds.): KES 2004, LNAI 3215, pp. 187-195, 2004.

In a further aspect of the present invention a system for recommending a service, in particular a healthcare service, to a particular user is presented, the system comprising a processor and a computer-readable storage medium, wherein the computer-readable storage medium contains instructions for execution by the processor, wherein the instructions cause the processor to perform the steps of:
selecting from a plurality of users similar users that are similar to the particular user,
collecting services used by similar users,
determining the suitability of services describing their intended use with respect to a user's profile, and
recommending a service for use by the particular user from the collected services based on the suitability of the collected services for the particular user and based on the number of times a service was recommended to similar users and/or the number of similar users to which a service was recommended by a recommendation giver, for instance by a care provider for recommending healthcare services, taking into account a reputation level of said recommendation givers.

In still another aspect of the present invention a system for recommending a service, in particular a healthcare service, to a particular user is presented, the system comprising:
a selector configured to select from a plurality of users similar users that are similar to the particular user,
a collector configured to collect services used by similar users,
a suitability determination unit configured to determine the suitability of services describing their intended use with respect to a user's profile, and
a recommender configured to recommend a service for use by the particular user from the collected services based on the suitability of the collected services for the particular user and based on the number of times a service was recommended to similar users and/or the number of similar users to which a service was recommended by a recommendation giver, for instance by a care provider for recommending healthcare services, taking into account a reputation level of said recommendation givers.

According to this aspect meaningful recommendations of services to users of a portal or platform, where a multitude of services are available, can be made, which is particularly of relevance when the services are healthcare related services and when care providers or other health related professionals such as dieticians or physical therapists are involved as recommendation givers (i.e. persons providing recommendations) in recommending these services to users.

Input from recommendation givers may be used to determine if a service should be recommended for a particular user. In many cases a care provider will recommend specific services to their patients, as the user profile of these patients is known in the system. This prescribing behavior of care providers can be used to determine which services are endorsed by care providers for which type of users. By combining the prescribing behavior of care providers with a reputation measure of these care providers it is possible to improve the recommendations even further by giving care providers with a high reputation a stronger weight in the calculation of recommendations.

According to the present invention services used by similar users (in the past or present) are collected and evaluated. This shall generally be understood in the context of the present invention as collecting information, which services have been used. In preferred embodiments, this may further be understood as collecting various additional pieces of information regarding services, such as which kinds or types of services have been used, how long or to which extent services have been used, where services have been used, how often services have been used, etc.

In preferred embodiments the systems and corresponding methods use the user profile and calculate to what extent the user profile matches the intended use of a service. An intended use of a service can include both information for which users this service is appropriate (e.g. a weight loss service is intended for users with a too high Body Mass Index and who are interested in losing weight) as well as information for which users this service is not appropriate (e.g. an extreme sports program is not intended for users with heart problems or osteoporosis).

In yet further aspects of the present invention, there are provided corresponding methods as well as a non-transitory computer-readable recording medium that stores therein a computer program product, which, when executed by a processor, causes the method disclosed herein to be performed.

Preferred embodiments of the invention are defined in the dependent claims. It shall be understood that the claimed systems, methods and medium have similar and/or identical preferred embodiments as the claimed system and as defined in the dependent claims.

According to a preferred embodiment the instructions further cause the processor to determine the level of similarity for a plurality of users and to select similar users based on the determined level of similarity. This increases the accuracy and effectiveness of recommended services.

In another embodiment the instructions further cause the processor to determine for collected services the level of satisfaction of similar users based on direct feedback from said similar users and/or actual usage of services by said similar users. For this purpose an interface for obtaining direct feedback and/or information about actual usage of services by users and/or measurement means for measuring actual usage of services by users including usage frequency and/or usage duration may be provided. Hence, the information for determining the level of similarity is preferably selected in an automated manner.

Preferably, the instructions further cause the processor to
determine the level of similarity for a plurality of users based on the profile of the users,
select similar users based on the determined level of similarity,
determine the suitability of collected services describing their intended use with respect to a user's profile, and
recommend a service for use by the particular user from the collected services based on the determined levels of satisfaction and the suitability of the collected services for the particular user.
   This further helps in the selection of recommendations that are most appropriate and effective for the particular user.

Advantageously, the instructions further cause the processor to recommend a service for use by the particular user from the collected services based on the determined levels of satisfaction and based on the number of times a service was recommended to similar users and/or the number of similar users to which a service was recommended. This also increases the accuracy and effectiveness of recommended services.

While the present invention can generally be applied for recommending any kind of services, it finds particular application in the field of healthcare, i.e. the system is preferably provided for recommending a healthcare service to a particular user. In this case the instructions preferably further cause the processor to recommend a healthcare service for use by the particular user from the collected healthcare services based on the determined levels of satisfaction and based on the number of times a service was recommended to similar users and/or the number of similar users to which a service was recommended by a care provider. As mentioned above, the instructions further cause the processor to preferably take into account a reputation level of said care providers in the recommendation of a healthcare service.

In another embodiment the instructions further cause the processor to determine for the respective collected services a combined satisfaction level from the determined level of satisfaction of similar users and to recommend a service for use by the particular user from the collected services based on the combined satisfaction level. The combined satisfaction level may e.g. be the average, a mean, a summation, etc. of the levels of satisfaction of similar users. This embodiment further increases the accuracy.

Optionally, the instructions further cause the processor to determine the suitability of a service for a user based on the profile of the user and the intended use of the service. Particularly, one or more exclusion criteria may be used for determining the suitability of a service for a user, an exclusion criterion indicating which users can or shall not use a particular service. Preferably, one or more exclusion criteria may be used that take into account availability, affordability and/or accessibility of a service for a user.

In other embodiments, the instructions further cause the processor to determine the reputation level of said recommendation givers, in particular of care providers, e.g. based on the number and/or quality of publications, the scientific H-index, recommendations, scores and/or ratings given by users, experts and/or other recommendation givers, and/or the outcome of prior use of services recommended by said recommendation giver, in particular of healthcare services recommended by a care provider.

### BRIEF DESCRIPTION OF THE DRAWINGS

These and other aspects of the invention will be apparent from and elucidated with reference to the embodiment(s) described hereinafter. In the following drawings

FIG. 1 shows a schematic diagram of the general layout of a system according to the present invention,

FIG. 2 shows a flow chart of a first embodiment of a method according to the present invention,

FIG. 3 shows a schematic diagram of a first embodiment of a system according to the present invention,

FIG. 4 shows a flow chart of a second embodiment of a method according to the present invention,

FIG. 5 shows a schematic diagram of a second embodiment of a system according to the present invention,

FIG. 6 shows a flow chart of a third embodiment of a method according to the present invention,

FIG. 7 shows a flow chart of a fourth embodiment of a method according to the present invention, and

FIG. 8 shows a schematic diagram of a third embodiment of a system according to the present invention.

### DETAILED DESCRIPTION OF THE INVENTION

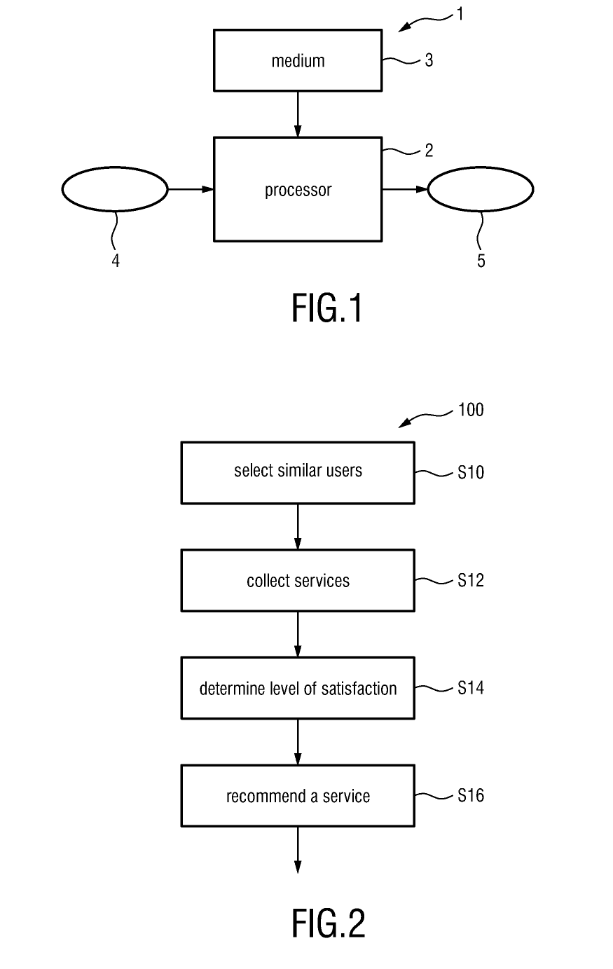

FIG. 1 shows a schematic diagram of the general layout of a system 1 for recommending a service for use by a particular user according to the present invention. The system 1 comprises a processor 2 and a computer-readable storage medium 3. The computer-readable storage medium 3 contains instructions for execution by the processor 2. These instructions cause the processor 2 to perform the steps of a method as will be illustrated in the following by use of flow charts showing different embodiments of such a method. The processor 2 processes information 4 obtained from an input unit (e.g. an electronic user device, a user interface, a storage unit, a website, a platform, etc.) to generate recommendations 5 for output via an output unit (which may be the same as or separate from the input unit).

The processor 2 and the computer-readable storage medium 3 may be part of processing device, such as a PC, workstation, laptop, tablet or smartphone, wherein the medium 3 can be coupled to the processor 2 via a corresponding interface, such as a USB interface, DVD drive, etc. In other embodiments, the medium 3 is located away from the processor 2, such as a server connected to the Internet or another network (e.g. a hospital network or communications network) to which the processor 2 is coupled as well. In an embodiment the processor 2 may be part of a smartphone, which has remote access to a database of applications and which can download an application onto the smartphone for use.

FIG. 2 shows a flow chart of a first embodiment of a method 100 according to the present invention. In a first step S10 similar users that are similar to the particular user are selected from a plurality of users. In a second step S12 services used by similar users are selected. In a third step S14 for collected services the level of satisfaction of similar users using the respective collected service is determined. In a fourth step S16 a service is recommended for use by the particular user from the collected services based on the determined levels of satisfaction of similar users.

Similarity is e.g. based on user profiles for which a distance function is defined that computes (relative) closeness of profiles (closer means more similar), i.e. the (relative) similarity can be defined that depends on how (relatively) close the parameters of the two profiles (e.g., age, gender) are. A strongly simplified example, in which profiles only use age and gender as parameters, shall be used to explain this. Then the distance between user profiles could be defined as the difference in age plus 10 additional points in case the gender differs. So, the distance between a 30-year old female and a 40-year old female would be 10, but the distance between the same 30-year female and a 33-year old male would be 3+10=13 and therefore actually larger than the distance to the 40-year old female.

For determining (relative) similarity, a minimum threshold (minimal closeness) may be used. The group of similar users is restricted to have a minimum closeness to the particular user. In the example of the 30-year old female a minimum closeness of 12 would mean the 40-year old female would qualify but the 33-year old male would not.

As mentioned above, the problem of profile matching is generally known, and the known examples are much more specific, for instance a 35-years-old male, 1.82 cm tall, with strong interests in fantasy novels and Japanese comics, fair interest in politics and no interest in football.

The selection of services used by similar users generally depends on the application domain. One application domain is the healthcare domain. In that case services are generally prescribed to a user (patient) by a professional caregiver. In this setting the prescription of such services is well administered. In other domains this might be more difficult but part of that knowledge could be in the public domain or otherwise potentially be acquired from the respective service providers. It should be noted that perfect knowledge about all the services used by similar users is generally not needed, the proposed idea still works with any (partial) knowledge being available or in situations in which there is some knowledge available about the use of certain services by other users.

The level of satisfaction may be based on various factors: user satisfaction surveys, service usage frequency and/or service usage duration. The first factor is explicitly related to satisfaction, the other two are implicitly related to satisfaction (where more frequent and longer users of a service are seen as more satisfied). Hence, the level of satisfaction of a user of a service can be determined in several ways. An often used method is direct feedback from a user, for instance by means of a questionnaire. Direct feedback from a user is complemented by taking the actual usage of the service by the user into account. The actual usage can give additional insights into important factors such as real service utilization (independent from candor or memory of the user) and relative scaling of service usefulness by different users. Actual usage of a service by a user through a portal or platform can be determined by IT tools such as monitoring and logging.

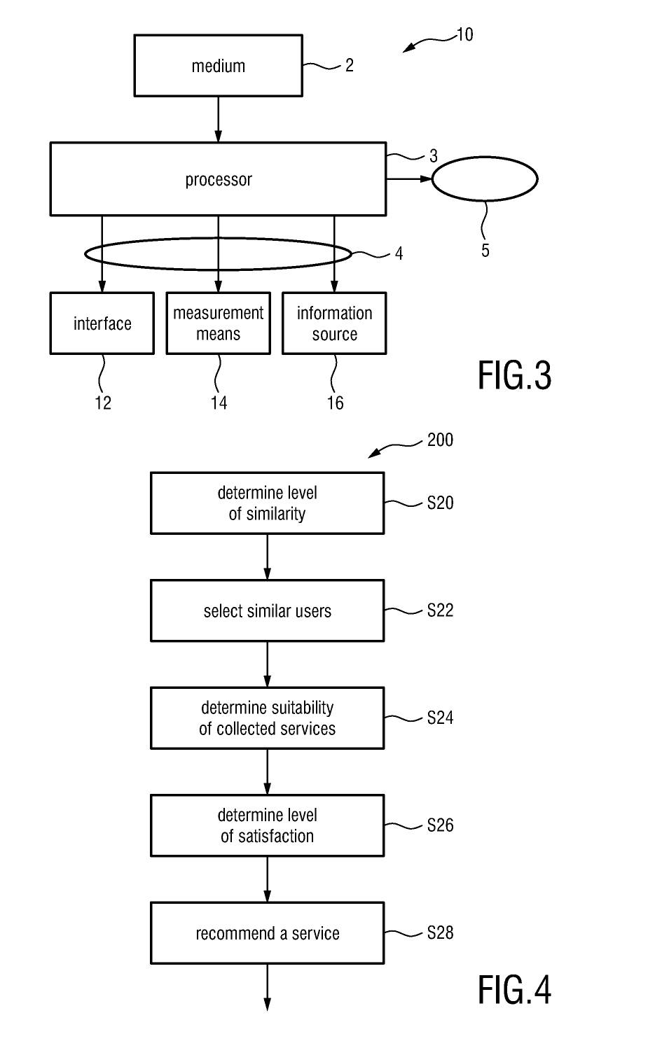

A corresponding first embodiment of a system 10 according to the present invention is depicted in FIG. 3. Said system comprises an interface 12 for obtaining direct feedback and/or information about actual usage of services by users. Such an interface may be any means by which a user can input feedback and/or information, e.g. a terminal station, a smartphone, a computer, a particular website that can be accessed by the user, etc. Generally, however, to obtain feedback by a user does not necessarily require a digital interface. The user can fill in a paper questionnaire that is later processed and transformed into computer-readable (e.g. digital) format automatically or manually.

Further, the system 10 comprises measurement means 14 for measuring actual usage of services by users including usage frequency and/or usage duration. Such measurement means 14 may be any means that are used by the user when using a service, e.g. a medical device that is used for applying a medical treatment, a computer that is used for reading a tutorial, a smartphone when getting instructions or reminders, etc. Further (not necessarily medical) devices that can track actual usage and may be used as measurement means 14 are all kinds of monitoring devices (including wearables) that form part of the service in question (e.g., a weight scale for a weight management service).

Further, an information source unit 16 may be provided for storing other input information 4, e.g. information about services used by other users, user profiles, similarity data, etc. for use by the processor 2 for generating recommendations 5. Said information storage unit 16 may e.g. be a storage (e.g. on a workstation, a server, in a network, in the cloud, etc.), a user interface, a website or database that can be searched by the processor 2, etc.

FIG. 4 shows a flow chart of a second embodiment of a method 200 according to the present invention which may be carried out by a system 1 depicted in FIG. 1. In a first step S20 the level of similarity for a plurality of users is determined based on the profile of the users. In a second step S22 similar users are selected from said plurality of users based on the determined level of similarity. In a third step S24 the suitability of collected services describing their intended use with respect to a user's profile is determined. In a fourth step S26 for collected services the level of satisfaction of similar users using the respective collected service is determined. In a fifth step S28 a service is recommended for use by the particular user from the collected services based on the determined levels of satisfaction and the suitability of the collected services for the particular user.

For instance, in an embodiment one or more exclusion criteria for determining the suitability of a service for a user are used, wherein an exclusion criterion indicates which users can or shall not use a particular service. Such exclusion criteria may take into account availability, affordability and/or accessibility of a service for a user.

In another embodiment the recommendation of a service may be made based on the determined levels of satisfaction and based on the number of times a service was recommended to similar users and/or the number of similar users to which a service was recommended.

Further, for the respective collected services a combined satisfaction level (e.g. an average, a mean, etc. of the single levels of satisfaction of a service) may be determined from the determined level of satisfaction of similar users, which may then be used in the recommendation of a service in steps S16 or S28 for use by the particular user from the collected services.

The proposed system is preferably provided for recommending a healthcare service to a particular user (e.g. a patient). Accordingly, a healthcare service is preferably recommended for use by the particular user from the collected healthcare services based on the determined levels of satisfaction and based on the number of times a service was recommended to similar users and/or the number of similar users to which a service was recommended by a care provider. Further, a reputation level of said care providers is preferably taken into account in the recommendation of a healthcare service.

In an exemplary implementation of a preferred embodiment the proposed system has the following elements as starting point:
A fairly large set U of users (e.g. many thousands) that make use of (part of) a predefined set of services S.
A user profile comprising a list of user profile parameters, e.g., age, gender, nationality, geographical location, medical conditions, medications, etc.
A function profiledist(p,p′) that calculates for each pair of user profiles p and p′ their distance (lower result means that the profiles are closer to each other).
For each user u in U the user profile userprof(u) of that user comprising the user profile parameters pertaining to u.
The subset of services from S used by a specific user u: servused(u).
For each user u in U and each s in servused(u)
   Satisfaction survey(s) from u for s from which a survey satisfaction level surveysatlevel(u,s) can be expressed as a score on a linear scale (higher score for a higher satisfaction from the survey).
   Service usage statistics of s by u, in particular servfreq(u,s) (service frequency, i.e., how often s is used by u) and servduration(u,s) (service duration, i.e., average length of use of s by u).

It shall be noted that a typical scenario for which this holds is a portal/website giving access to multiple services. The portal has drawn a large number of users filling in their own profiles as well as service satisfaction surveys on a regular basis. By monitoring and logging service usage statistics can be generated.

Based on the above mentioned elements the recommendation of services can now be refined as follows:
1. Choose a threshold value minclose and determine for each u in U the set simusers(u, minclose) of users similar to u up to a certain threshold (representing the desired minimum level of closeness) by:

u′∈simusers(u, minclose) [symbol] profiledist(userprof(u), userprof(u′))≦minclose.
2. For each u in U define simserv(u, minclose) as the set of all services used by users similar to u:

s∈simserv(u, minclose) [symbol] ∃u′{u′∈simusers(u, minclose) [symbol] s∈servused(u′)}.
3. Define for each u in U and each s in servused(u) an overall satisfaction level satlevel(u,s) as:

surveysatlevel(u,s)*servfreq(u,s)*servduration(u,s).

Hereby, many more variants for satlevel can be thought of in addition to this straightforward linear combination of these three contributing factors.
4. Define for each u in U and each s in simserv(u, minclose) a satisfaction level of s for users similar to u, satsimusers(s, u, minclose) as:

average{satlevel(u′,s)|u′∈simusers(u, minclose) [symbol] s∈servused(u′)}.

Hereby, variants for satsimusers can be thought of beyond a straightforward average, e.g., giving different weights to different similar users like a higher weight for users closer to u.

Now, to present a recommendation of services to a specific user the results from step 4 are ordered from highest satisfaction level first to lowest satisfaction level last.

The (social) recommendation of services can be thought of by the following simple example. A portal shall be considered providing seniors access to several services, including a shopping assistance service and a haircut at home service. The user profile is an extremely simple one: only age and gender. Profiledist(p, p′) is defined as

1−1/(abs(age(p)−age(p′))+1) if gender(p)=gender(p′) and 1 otherwise.

This yields a value of 0 for same age, same gender; 1 for different gender; between 0 and 1 for same gender, different age.

Now, the following six seniors using this portal (John and Susan are only included for reference later on) shall be considered:
Barbara (75, female), Jennifer (75, female), John (75, male), Linda (74, female), Mary (79, female) and Susan (82, female). Barbara uses neither the shopping assistance service nor the haircut at home service. Jennifer uses only the shopping assistance service. Linda and Mary both use the shopping assistance service and the haircut at home service. For both the shopping assistance service and the haircut at home service a single survey with a linear scale from 1 to 5 has been held and usage statistics (frequency in times per month, duration in average number of minutes) have been observed with the following results:
surveysatlevel(Jennifer, shopping assistance)=3
surveysatlevel(Linda, shopping assistance)=2
surveysatlevel(Mary, shopping assistance)=5
surveysatlevel(Linda, haircut at home)=4
surveysatlevel(Mary, haircut at home)=2
servfreq(Jennifer, shopping assistance)=4
servfreq(Linda, shopping assistance)=2
servfreq(Mary, shopping assistance)=8
servfreq (Linda, haircut at home)=2
servfreq (Mary, haircut at home)=1
servduration(Jennifer, shopping assistance)=60
servduration(Linda, shopping assistance)=45
servduration(Mary, shopping assistance)=90
servduration(Linda, haircut at home)=45
servduration(Mary, haircut at home)=30

For this example Barbara shall be taken as the target for recommendation and 0.8 as the threshold value minclose. First, the closeness of the profiles of the five others in relation to Barbara shall be calculated:
profiledist(userprof(Barbara), userprof(Jennifer))=0
profiledist(userprof(Barbara), userprof(John))=1
profiledist(userprof(Barbara), userprof(Linda))=0.5
profiledist(userprof(Barbara), userprof(Mary))=0.8
profiledist(userprof(Barbara), userprof(Susan))=0.875.

From this, it can be found that John and Susan do not qualify as users similar to Barbara:

simusers(Barbara, 0.8)={Jennifer, Linda, Mary}.

Since Linda (and Mary) uses both the shopping assistance service and the haircut at home service

simserv(Barbara, 0.8)={shopping assistance, haircut at home}.

Next, overall satisfaction levels are calculated:
satlevel(Jennifer, shopping assistance)=3*4*60=720
satlevel (Linda, shopping assistance)=2*2*45=180
satlevel (Mary, shopping assistance)=5*8*90=3600
satlevel (Linda, haircut at home)=4*2*45=360
satlevel (Mary, haircut at home)=2*1*30=60.

This leads to the final computation:

satsimusers(shopping assistance, Barbara, 0.8)=(720+180+3600)/3=1500

and
satsimusers(haircut at home, Barbara, 0.8)=(360+60)/2=210.

In this example the shopping assistance service would merit a much stronger recommendation for Barbara than the haircut at home service. In this specific example the result is dominated by Mary's high levels of survey satisfaction, frequency and duration for the shopping assistance service. In the simple algorithms described above the calculations for different services are not normalized. This gives skewed results that can be improved upon in practical settings. One possibility is to use the deviation (as a percentage) of the overall satisfaction level of a specific user with respect to the average overall satisfaction level of all users of a service instead of the overall satisfaction level of that specific user as an absolute value as used above.

FIG. 5 shows a schematic diagram of a second embodiment of a system 20 for recommending a service to a particular user according to the present invention. The system comprises a selector 22 configured to select from a plurality of users similar users that are similar to the particular user, a collector 24 configured to collect services used by similar users, a level of satisfaction determination unit 26 configured to determine for collected services the level of satisfaction of similar users using the respective collected service, and a recommender 28 configured to recommend a service for use by the particular user from the collected services based on the determined levels of satisfaction. The elements of the system may be implemented as separate or common hardware elements, as software elements or as a combination of hardware and software elements.

According to the above explained embodiments of the proposed system and method the similarity of users, e.g. of a portal or platform, is determined and recommendations for services are based on what services similar users are satisfied with. In the following embodiments of the proposed system and method services are recommended to users, e.g. of a portal or platform, where a multitude of services are available, which is particularly of relevance when the services are healthcare related services and when care providers or other health related professionals such as dieticians or physical therapists are involved in recommending these services to users.

Preferred embodiments are based on using the user profile and calculating to what extent the user profile matches the intended use of a service. An intended use of a service can include both information for which users this service is appropriate (e.g. a weight loss service is intended for users with a too high Body Mass Index and who are interested in losing weight) as well as information for which users this service is not appropriate (e.g. an extreme sports program is not intended for users with heart problems or osteoporosis). Further embodiments use the input from care providers to determine if a service should be recommended for a particular user. In many cases a care provider will recommend specific services to their patients, as the user profile of these patients is known in the system, this prescribing behavior of care providers can be used to determine which service are endorsed by care providers for which type of users. By combining the prescribing behavior of care providers with a reputation measure of these care providers it is possible to improve the recommendations even further by giving care providers with a high reputation a stronger weight in the calculation of recommendations.

When people can get access to a multitude of services through a single portal or platform, it can be challenging to recommend services that are both relevant and suitable to them. To address this issue it helps to compare the intended use of the services with the user's profile and take into account the recommendations of services by care providers for similar users.

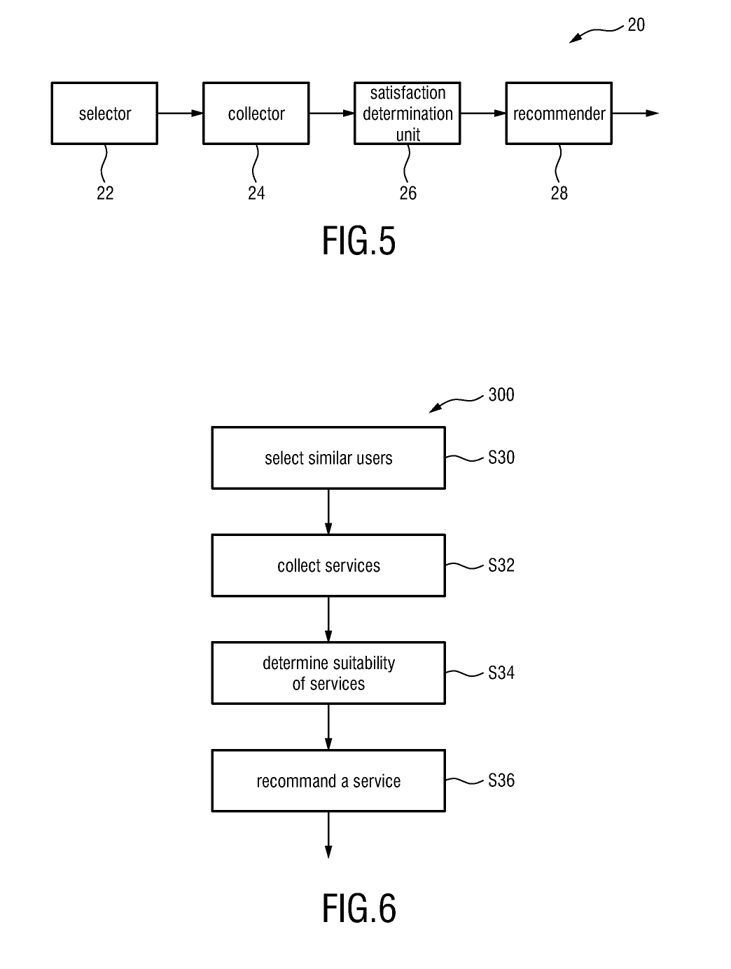

FIG. 6 shows a flow chart of a third embodiment of a method 300 according to the present invention, which may be carried out by a system 1 as depicted in FIG. 1. In a first step S30 from a plurality of users similar users that are similar to the particular user are selected. In a second step S32 services used by similar users are collected. In a third step S34 the suitability of services describing their intended use with respect to a user's profile are determined. In a fourth step S36 a service is recommended for use by the particular user from the collected services based on the suitability of the collected services for the particular user and based on the number of times a service was recommended to similar users and/or the number of similar users to which a service was recommended by a care provider, taking into account a reputation level of said care providers.

Registering the recommendations by care providers for particular patients is fairly straight forward when these care providers make their recommendations through the portal or platform. It assumes that care providers have a way to access the portal or platform and can recommend or prescribe certain services for their patients. Based on the user profiles of these patients this prescribing behavior can be transformed into service recommendations for specific user profiles. This will require a sufficiently large pool of patients to be able to derive a reliable recommendation model. The model can be trained faster by asking the care providers to make their recommendation more explicit by letting them indicate which elements of the user's profile are used as the basis for the recommendation of a specific service.

Determining the reputation of care providers has a wide range of solutions, some of those can be combined to calculate a well-balanced reputation of care provider. Scientific reputation can be based on the generally known H-index, which is an index that attempts to measure both the productivity and impact of the published work of a scientist or scholar. Clinical reputation can be based on the outcomes of the patients of these care providers. This will require adjustments for case mix, as better care providers will most likely also get sicker patients referred to them. Risk adjustment models are available that can help adjust for case mix differences. Patient satisfaction can be based on websites where patients can rate their doctors such as http://www.ratemds.com. A last contributor to reputation could be to let other care providers rate their colleagues.

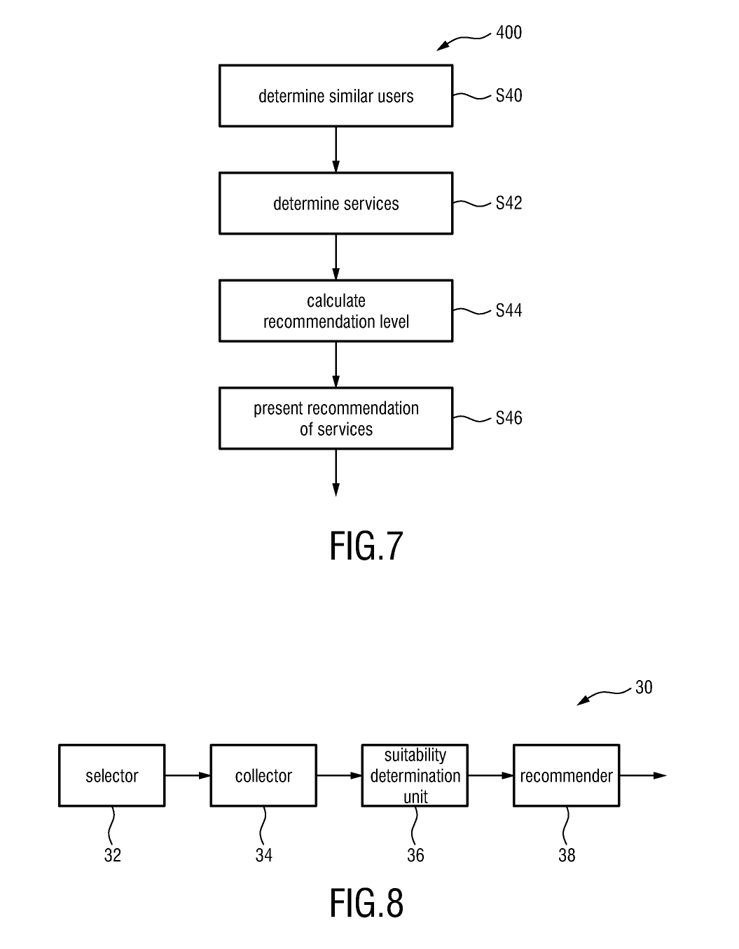

FIG. 7 shows a flow chart of a third embodiment of a method 400 according to the present invention, which may be carried out by a system 1 as depicted in FIG. 1. In a first step S40 users similar (e.g. using profiles) to the given user are determined up to a certain threshold (minimum level of closeness). In a second step S42 the services are determined for which a care provider prescribed this service for a similar user that have a minimum level of suitability for the user but for which there is no match between the user's profile and an exclusion criterion in the intended use of this service. In a third step S44 for each service in the collection from step S42 a recommendation level is calculated for this service based on for how many similar users this service was prescribed taking into account the reputation level of the prescribing care provider. This can be adapted by giving different weights to different similar users (higher weight for users closer to the given user). In a fourth step S46 a recommendation of services is presented to the given user by ordering the results from step S44 from highest recommendation level first to lowest recommendation level last.

These recommendations can be extended by taking into account the satisfaction of similar users with these services, as described above. This is particularly of relevance for services for which no care provider recommendations or prescriptions are available.

The service recommendations can be shown directly to the user to find services that could be relevant and suitable for him or to the care provider of the user to help decide which services to prescribe for this user based on what other care providers have recommended for similar users. Suitability of a service for a specific user where services are excluded when the user profile and exclusion criteria match should be interpreted broadly: these may include, for instance, availability (can/does/wants the care provider deliver the service, this may depend on geographic location and local circumstances), affordability (chance of costs being covered by a payer such as insurer, hospital or patient) and accessibility (e.g., available and acceptable transportation facilities for the user).

In the description above only services that are actually prescribed to similar users are taken into account. In other embodiments service recommendation scores from care providers are included instead of the binary score of prescribed or not prescribed.

In an exemplary implementation of a preferred embodiment the proposed system has the following elements as starting point:
A fairly large set U of users (e.g. many thousands) that make use of (part of) a predefined set of services S, and a set P of care providers that prescribe such services to those users.
A user profile comprising a list of user profile parameters (e.g., age, gender, nationality, geographical location, medical conditions, medications, etc.); for each user u in U the user profile userprof(u) of that user comprising the specific user profile parameters pertaining to u.
A function profiledist(up,up′) that calculates for each pair of user profiles up and up′ their distance (lower result means that the profiles are closer to each other)
The subset of care providers from P taking care of a specific user u: careprov(u).
For each user u in U and each p in careprov(u) the set of services from S prescribed by p for u: presserv(p,u).
A set of exclusion criteria E and for each s in S a subset E(s) from E of exclusion criteria related to the intended use of s; and for each user profile up and each subset C from E a function match(up,C) that indicates whether users with profile up should be excluded on basis of one of the criteria in C.
For each user u in U and each s in S a suitability score suitscore(s,u) of s for u.
For each p in P the reputation level of p: replevel(p).
   Based on the elements above the recommendation of services can now be refined as follows:
1. Choose a threshold value minclose and determine for each u in U the set simusers(u, minclose) of users similar to u up to a certain threshold (representing the desired minimum level of closeness) by

simusers(u, minclose)={u′|u′∈U [symbol] profiledist(userprof(u), userprof(u′))≦minclose}.
2. Choose a threshold value minsuit and determine for each u in U the set suitserv(u, minsuit) of services suitable for u up to a certain threshold, excluding services considered inappropriate for u by

suitserv(u, minsuit)={s|∃p∃u′[u′∈simusers(u, minclose) [symbol] p∈careprov(u′) [symbol] s∈presserv(p,u′) [symbol] suitscore(s,u)≧minsuit [symbol] [symbol] match(userprof(u),E(s))]}
3. Define for each u in U and each s in suitserv(u, minsuit) an overall recommendation level:

reclevel(u,s)=Σ{replevel(p)|∃u′[u′∈simusers(u, minclose) [symbol] p∈careprov(u′) [symbol] s∈presserv(p,u′)]}

Variants for reclevel can be thought of beyond a straightforward sum, e.g., giving different weights to different similar users like a higher weight for users closer to u.

Now, to present a recommendation of services to a specific user the results from step 3 are ordered from highest recommendation level first to lowest recommendation level last.

FIG. 8 shows a schematic diagram of a third embodiment of a system 30 for recommending a service to a particular user according to the present invention. The system 30 comprises a selector 32 configured to select from a plurality of users similar users that are similar to the particular user, a collector 34 configured to collect services used by similar users, a suitability determination unit 36 configured to determine the suitability of services describing their intended use with respect to a user's profile, and a recommender 38 configured to recommend a service for use by the particular user from the collected services based on the suitability of the collected services for the particular user and based on the number of times a service was recommended to similar users and/or the number of similar users to which a service was recommended by a care provider, taking into account a reputation level of said care providers.

The present invention can e.g. be applied in portals/platforms that offer a multitude of services to its users and that want to recommend specific services to each user which should be relevant and suitable for those users. An example of such a portal is the Personal Health Book offered by the applicant.

Furthermore, the different embodiments can take the form of a computer program product accessible from a computer usable or computer readable medium providing program code for use by or in connection with a computer or any device or system that executes instructions. For the purposes of this disclosure, a computer usable or computer readable medium can generally be any tangible device or apparatus that can contain, store, communicate, propagate, or transport the program for use by or in connection with the instruction execution device.

In so far as embodiments of the disclosure have been described as being implemented, at least in part, by software-controlled data processing devices, it will be appreciated that the non-transitory machine-readable medium carrying such software, such as an optical disk, a magnetic disk, semiconductor memory or the like, is also considered to represent an embodiment of the present disclosure.

The computer usable or computer readable medium can be, for example, without limitation, an electronic, magnetic, optical, electromagnetic, infrared, or semiconductor system, or a propagation medium. Non-limiting examples of a computer readable medium include a semiconductor or solid state memory, magnetic tape, a removable computer diskette, a random access memory (RAM), a read-only memory (ROM), a rigid magnetic disk, and an optical disk. Optical disks may include compact disk-read only memory (CD-ROM), compact disk-read/write (CD-R/W), and DVD.

Further, a computer usable or computer readable medium may contain or store a computer readable or usable program code such that when the computer readable or usable program code is executed on a computer, the execution of this computer readable or usable program code causes the computer to transmit another computer readable or usable program code over a communications link. This communications link may use a medium that is, for example, without limitation, physical or wireless.

A data processing system or device suitable for storing and/or executing computer readable or computer usable program code will include one or more processors coupled directly or indirectly to memory elements through a communications fabric, such as a system bus. The memory elements may include local memory employed during actual execution of the program code, bulk storage, and cache memories, which provide temporary storage of at least some computer readable or computer usable program code to reduce the number of times code may be retrieved from bulk storage during execution of the code.

Input/output, or I/O devices, can be coupled to the system either directly or through intervening I/O controllers. These devices may include, for example, without limitation, keyboards, touch screen displays, and pointing devices. Different communications adapters may also be coupled to the system to enable the data processing system to become coupled to other data processing systems, remote printers, or storage devices through intervening private or public networks. Non-limiting examples are modems and network adapters and are just a few of the currently available types of communications adapters.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different advantages as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

1. A system for recommending a service for use by a particular user, the system comprising a processor and a computer-readable storage medium, wherein the computer-readable storage medium contains instructions for execution by the processor, wherein the instructions cause the processor to perform the steps of:
selecting from a plurality of users similar users that are similar to the particular user,
collecting services used by similar users,
determining for collected services the level of satisfaction of similar users using the respective collected service, and
recommending a service for use by the particular user from the collected services based on the determined levels of satisfaction of similar users.

2. The system as claimed in claim 1,
wherein the instructions further cause the processor to
determine the level of similarity for a plurality of users and
select similar users based on the determined level of similarity.

3. The system as claimed in claim 1,
wherein the instructions further cause the processor to determine for collected services the level of satisfaction of similar users based on direct feedback from said similar users and/or actual usage of services by said similar users.

4. The system as claimed in claim 3,
further comprising an interface for obtaining direct feedback and/or information about actual usage of services by users.

5. The system as claimed in claim 3,
further comprising measurement means for measuring actual usage of services by users including usage frequency and/or usage duration.

6. The system as claimed in claim 1,
wherein the instructions further cause the processor to
determine the level of similarity for a plurality of users based on the profile of the users,
select similar users based on the determined level of similarity,
determine the suitability of collected services describing their intended use with respect to a user's profile, and
recommend a service for use by the particular user from the collected services based on the determined levels of satisfaction and the suitability of the collected services for the particular user.

7. The system as claimed in claim 1,
wherein the instructions further cause the processor to recommend a service for use by the particular user from the collected services based on the determined levels of satisfaction and based on the number of times a service was recommended to similar users and/or the number of similar users to which a service was recommended.

8. The system as claimed in claim 1, wherein the system is provided for recommending a healthcare service to a particular user,
wherein the instructions further cause the processor to recommend a healthcare service for use by the particular user from the collected healthcare services based on the determined levels of satisfaction and based on the number of times a service was recommended to similar users and/or the number of similar users to which a service was recommended by a care provider.

9. The system as claimed in claim 8,
wherein the instructions further cause the processor to take into account a reputation level of said care providers in the recommendation of a healthcare service.

10. The system as claimed in claim 1,
wherein the instructions further cause the processor to determine for the respective collected services a combined satisfaction level from the determined level of satisfaction of similar users and to recommend a service for use by the particular user from the collected services based on the combined satisfaction level.

11. A method for recommending a service to a particular user, the method comprising the steps of:
selecting from a plurality of users similar users that are similar to the particular user,
collecting services used by similar users,
determining for collected services the level of satisfaction of similar users using the respective collected service, and
recommending a service for use by the particular user from the collected services based on the determined levels of satisfaction.

12. A system for recommending a service to a particular user, the system comprising:
a selector configured to select from a plurality of users similar users that are similar to the particular user,
a collector configured to collect services used by similar users,
a level of satisfaction determination unit configured to determine for collected services the level of satisfaction of similar users using the respective collected service, and
a recommender configured to recommend a service for use by the particular user from the collected services based on the determined levels of satisfaction.

13. A system for recommending a service to a particular user, the system comprising a processor and a computer-readable storage medium, wherein the computer-readable storage medium contains instructions for execution by the processor, wherein the instructions cause the processor to perform the steps of:
selecting from a plurality of users similar users that are similar to the particular user,
collecting services used by similar users,
determining the suitability of services describing their intended use with respect to a user's profile, and
recommending a service for use by the particular user from the collected services based on the suitability of the collected services for the particular user and based on the number of times a service was recommended to similar users and/or the number of similar users to which a service was recommended by a recommendation giver taking into account a reputation level of said recommendation givers.

14. The system as claimed in claim 6,
wherein the instructions further cause the processor to determine the suitability of a service for a user based on the profile of the user and the intended use of the service.

15. The system as claimed in claim 14,
wherein the instructions further cause the processor to use one or more exclusion criteria for determining the suitability of a service for a user, an exclusion criterion indicating which users can or shall not use a particular service.

16. The system as claimed in claim 15,
wherein the instructions further cause the processor to use one or more exclusion criteria that take into account availability, affordability and/or accessibility of a service for a user.

17. The system as claimed in claim 9,
wherein the instructions further cause the processor to determine the reputation level of said recommendation givers.

18. A method for recommending a service to a particular user, the method comprising the steps of:
selecting from a plurality of users similar users that are similar to the particular user,
collecting services used by similar users,
determining the suitability of services describing their intended use with respect to a user's profile, and
recommending a service for use by the particular user from the collected services based on the suitability of the collected services for the particular user and based on the number of times a service was recommended to similar users and/or the number of similar users to which a service was recommended by a recommendation giver taking into account a reputation level of said recommendation givers.

19. A system for recommending a service to a particular user comprising:
a selector configured to select from a plurality of users similar users that are similar to the particular user,
a collector configured to collect services used by similar users,
a suitability determination unit configured to determine the suitability of services describing their intended use with respect to a user's profile, and
a recommender configured to recommend a service for use by the particular user from the collected services based on the suitability of the collected services for the particular user and based on the number of times a service was recommended to similar users and/or the number of similar users to which a service was recommended by a recommendation giver taking into account a reputation level of said recommendation givers.

20. A non-transitory computer-readable recording medium that stores therein a computer program product, which, when executed by a processor, causes the method as claimed in claim 11 to be performed.
